(19) United States
(12) Patent Application Publication
(10) Pub. No.: US 2023/0334917 A1
(43) Pub. Date: Oct. 19, 2023

(54) SYSTEM AND METHOD FOR FACILITATING OPTIMIZED DISTRIBUTION OF AUTOMOTIVE SIGNALS

(71) Applicant: CEREBRUMX LABS PRIVATE LIMITED, Gurgaon (IN)

(72) Inventors: Sandip Ranjhan, Delhi (IN); Sarika Gupta, Gurgaon (IN); Amit Gupta, Gurgaon (IN)

(21) Appl. No.: 18/134,521

(22) Filed: Apr. 13, 2023

Related U.S. Application Data
(60) Provisional application No. 63/330,744, filed on Apr. 13, 2022.

(51) Int. Cl. G07C 5/00; G07C 5/08

(52) U.S. Cl. CPC G07C 5/008; G07C 5/0816

(57) ABSTRACT

The present disclosure provides a system and a method facilitating optimized distribution of automotive signals across various consumers and providers. The system provides real-time data distribution to consumers, where the data is collected from a plurality of sources within a vehicle as well as different data providers. The system creates a profile pyramid, where basic signals in the incoming data are mapped to a base profile of the pyramid and includes additional and more advanced signals. The signal definition in each layer of the pyramid is based on common ontology and is agnostic of the signals defined by data providers. Each data consumer is tagged to a profile layer within the profile pyramid. A distributor distributes the data at a chosen frequency and sends multiple signals to different consumers without maintaining multiple copies of the configuration or incoming data.

### CROSS-REFERENCE TO RELATED APPLICATIONS

This application claims the benefit under 35 U.S.C. § 119(e) of U.S. Provisional Patent Application No. 63/330,744, which was filed Apr. 13, 2022 and titled “SYSTEM AND METHOD FOR FACILITATING OPTIMIZED DISTRIBUTION OF AUTOMOTIVE SIGNALS,” which is hereby incorporated herein by reference in its entirety.

### TECHNICAL FIELD

The embodiments of the present disclosure generally relate to systems and methods for distribution of real-time multiplexed automotive data across various consumers. More particularly, the present disclosure relates to a system and a method for facilitating optimized distribution of automotive signals.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Data ingestion rate for automotive data is a factor of the type of data signals as well as the data sampling rate, transmission, and collection rate used by original equipment manufacturers (OEMs). Data consumers, on the other hand, require real-time data related to only a subset of signals, from different providers and sometimes at a frequency, different from data provider transmission frequency. To add further complexity, multiple data consumers may need the same set of signals at a different frequency rate. To maintain the sanctity and relevance of real-time data, data must be sent to the consumers with minimal additional latency and without maintaining any consumer-specific copies.

While one data consumer may need specific trip signals from vehicles across data providers, other consumers may need a varying set of signals for the vehicles from the same data provider in real-time. Hence, the data distribution is complex and tedious. Further, distribution of real-time data for a single vehicle must be performed across consumers at the same time to maintain the time relevance. Specifically, signals in a specific category, related to a vehicle, must be distributed as per the desired and a subscribed frequency. Different consumers may subscribe for different signals at varying frequency. Furthermore, only relevant and subscribed signals must be distributed to the data consumer to ensure least processing overhead for both the distributor and the consumer. A data consumer interface for distributing the data may have to be consistent across all vehicles irrespective of the data provider interface. This consistency reduces the consumer overhead significantly.

There is, therefore, a need in the art to provide a system and a method that can mitigate the problems associated with the prior arts.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for generating an optimized distribution of data. The system may include a processor, and a memory operatively coupled to the processor, where the memory stores instructions to be executed by the processor. The processor may receive a plurality of signals from one or more consumers via a computing device. The plurality of signals may be generated by at least a vehicle associated with the one or more consumers. The processor may define one or more profiles associated with said at least vehicle based on one or more vehicle classes and a subscribed frequency. The processor may determine a rating for the received plurality of signals based on the defined one or more profiles. The processor may map the received plurality of signals to the defined one or more profiles based on the determined rating to generate a vehicle data stream with a data frequency. The processor may distribute the generated vehicle data stream to the one or more consumers.

In an embodiment, the received plurality of signals may include at least one of a sampling rate and a transmission rate.

In an embodiment, the generated data frequency may include at least one of a collector rate and a distributor rate.

In an embodiment, the one or more vehicle classes may include at least one of a fleet, an insurance, and a vehicle stability control (VSC).

In an embodiment, the subscribed frequency may be based on the transmission rate of the received plurality of signals.

In an embodiment, the data frequency may be based on a step size associated with the defined one or more profiles and a frequency counter.

In an embodiment, the system may include a distributed processing system that receives the plurality of signals with the transmission rate and distributes the generated vehicle data stream to the one or more consumers.

In an embodiment, the processor may dynamically create a plurality of spark jobs based on the received plurality of signals to be mapped with the one or more profiles.

In an embodiment, the processor may generate a distributed frequency array that may include the frequency counter and the step size to be mapped to the one or more profiles of said at least vehicle.

In an embodiment, the processor may process the generated distributed frequency array and a consumer bit mask associated with the one or more profiles of said at least vehicle.

In an embodiment, the processor may update a signal list associated with the vehicle data stream and ensure the mapping for all the received plurality of signals associated with the one or more profiles.

In an aspect, the present disclosure relates to a method for generating an optimized distribution of data. The method may include receiving, by a processor associated with the system, a plurality of signals from one or more consumers. The plurality of signals may be generated by at least a vehicle associated with the one or more consumers. The method may include defining, by the processor, one or more profiles associated with said at least vehicle based on one or more vehicle classes and a subscribed frequency. The method may include determining by the processor, a rating for the received plurality of signals based on the defined one or more profiles. The method may include mapping, by the processor, the received plurality of signals to the defined one or more profiles based on the determined rating for generating a vehicle data stream with a data frequency. The method may include distributing, by the processor, the generated vehicle data stream to the one or more consumers.

In an embodiment, the received plurality of signals may include at least one of a sampling rate and a transmission rate.

In an embodiment, the data frequency may be based on a step size associated with the defined one or more profiles and a frequency counter.

In an embodiment, the method may include dynamically creating, by the processor, a plurality of spark jobs based on the received plurality of signals to be mapped with the one or more profiles.

In an embodiment, the method may include generating, by the processor, a distributed frequency array that includes the frequency counter and the step size to be mapped to the one or more profiles of said at least vehicle.

In an embodiment, the method may include processing, by the processor, the generated distributed frequency array and a consumer bit mask associated with the one or more profiles of said at least vehicle.

In an embodiment, the method may include updating, by the processor, a signal list associated with the vehicle data stream and ensuring the mapping for all the received plurality of signals associated with the one or more profiles.

In an aspect, a non-transitory computer readable medium may include a processor with executable instructions that may cause the processor to receive a plurality of signals from one or more consumers via a computing device. The plurality of signals may be generated by at least a vehicle associated with the one or more consumers. The processor may define one or more profiles with said at least vehicle based on one or more vehicle classes and a subscribed frequency. The processor may determine a rating for the received plurality of signals based on the defined one or more profiles. The processor may map the received plurality of signals to the defined one or more profiles based on the determined rating to generate a vehicle data stream with a data frequency. The processor may distribute the generated vehicle data stream to the one or more consumers.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example representation of a network architecture for facilitating optimized distribution of data of automotive vehicles, in accordance with an embodiment of the present disclosure.

FIG. 2 illustrates a block diagram of an example system for facilitating optimized distribution of data of automotive vehicles, in accordance with an embodiment of the present disclosure.

FIG. 3 illustrates an example representation of a data distribution process of automotive signals, in accordance with an embodiment of the present disclosure.

FIG. 4 illustrates an example layered profile pyramid, in accordance with an embodiment of the present disclosure.

FIG. 5 illustrates an example profile pyramid based on consumer data, in accordance with an embodiment of the present disclosure.

FIG. 6 illustrates an example distribution frequency array, in accordance with an embodiment of the present disclosure.

FIG. 7 illustrates an example data signal distribution mechanism of the example system, in accordance with an embodiment of the present disclosure.

FIG. 8 illustrates an example method for generating and distributing vehicle data stream, in accordance with an embodiment of the present disclosure.

FIG. 9 illustrates an example computer system in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

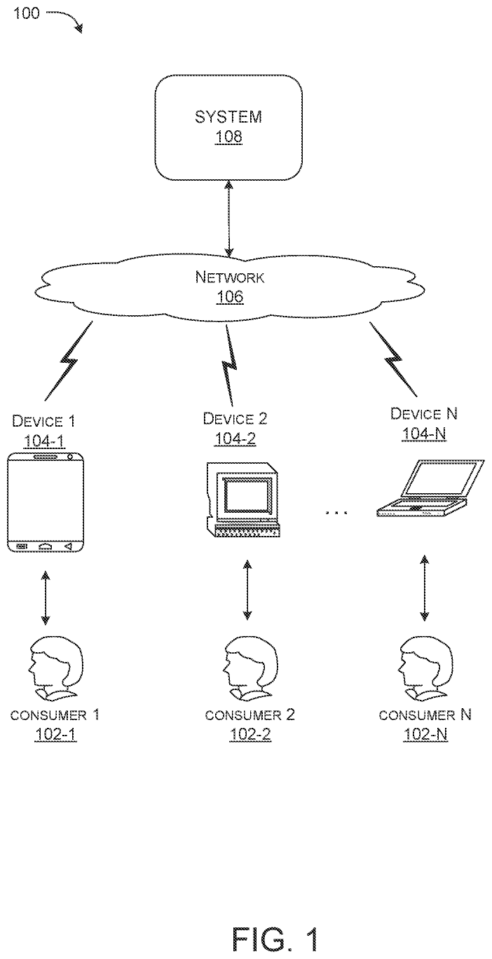

The various embodiments throughout the disclosure will be explained in more detail with reference to FIGS. 1-9.

FIG. 1 illustrates an example representation of a network architecture for facilitating optimized distribution of data of automotive vehicles, in accordance with an embodiment of the present disclosure.

As illustrated in FIG. 1, the network architecture 100 may include a system 108 connected to one or more computing devices 104-1, 104-2 . . . 104-N via a network 106. The one or more computing devices 104-1, 104-2 . . . 104-N may be interchangeably specified as a user equipment (UE) 104 and be operated by one or more consumers 102-1, 102-2 . . . 102-N. Further, the one or more consumers 102-1, 102-2 . . . 102-N may be interchangeably referred as a consumer 102 or consumers 102. The one or more consumers 102 may operate an automotive vehicle. The computing device 104 may act a provider which may receive a plurality of signals from the automotive vehicle and the send plurality of signals to the system 108 via the network 106. In an exemplary embodiment, the provider may also include a cloud interface, which may be accessed by the system 108.

In an embodiment, the computing devices 104 may include, but not be limited to, a mobile, a laptop, etc. Further, the computing devices 104 may include a smartphone, virtual reality (VR) devices, augmented reality (AR) devices, a general-purpose computer, desktop, personal digital assistant, tablet computer, and a mainframe computer. Additionally, input devices for receiving input from the consumer 102 such as a touch pad, touch-enabled screen, electronic pen, and the like may be used. A person of ordinary skill in the art will appreciate that the computing devices 104 may not be restricted to the mentioned devices and various other devices may be used.

In an embodiment, the network 106 may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network 106 may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system 108 may receive the plurality of signals from the consumers 102 via the computing device 104. The plurality of signals may be generated by at least a vehicle associated with the one or more consumers 102. The received plurality of signals may include any or a combination of a sampling rate and a transmission rate. The sampling rate may include the rate of sampling of one or more sensors within the vehicle. Further, the transmission rate may include the rate at which the vehicle sends the signal data to the system 108.

It may be understood that the system 108 may be required to generate meaningful and business impacting insights using the signals/data, which may be possible only if the data is relevant, consistent, and is received within minimal latency.

In an embodiment, trip automotive data may be collected from different sources of the vehicle operated by the consumers 102. While a consumer 102 may need specific trip signals from the vehicle across data providers, i.e. original equipment manufacturers (OEMs), other consumers 102 may require a varying set of signals for the vehicle from the same data provider (OEM) in real-time.

In an embodiment, based on the source of data of the vehicle, the system 108 may broadly categorize the data signals as, but not limited to, telematics, body control, advanced driver assistance systems (ADAS), diagnostics, and in-vehicle infotainment.

In an embodiment, the system 108 may define one or more profiles associated with the vehicle based on one or more vehicle classes and a subscribed frequency. The one or more vehicle classes may include, but not limited to, a fleet, an insurance, and a vehicle stability control (VSC). The subscribed frequency may be based on the transmission rate of the received plurality of signals. Further, the system 108 may determine a rating for the received plurality of signals based on the defined one or more profiles.

In an embodiment, the system 108 may map the received plurality of signals to the one or more profiles based on the determined rating to generate a vehicle data stream with a data frequency. The data frequency may be based on a step size associated with the defined one or more profiles and a frequency counter. The system 108 may be configured to generate a distributed frequency array that may contain the frequency counter and the step size to be mapped to the defined one or more profiles of the vehicle. Further, the system 108 may distribute the generated vehicle data stream to the one or more consumers 102.

In an embodiment, the system 108 may be configured to process the generated distributed frequency array and a consumer bit mask associated with the defined one or more profiles of the vehicle.

In an embodiment, the system 108 may include a distributed processing system (not shown) that may receive the plurality of signals with the transmission rate and distribute the generated vehicle data stream to the one or more consumers 102.

In an embodiment, the system 108 may dynamically create a plurality of spark jobs based on the received plurality of signals to be mapped with the one or more profiles. The plurality of spark jobs may ensure the mapping for all the received plurality of signals. Further, the system 108 may update a signal list associated with the vehicle data stream and ensure the mapping for all the received plurality of signals.

Although FIG. 1 shows exemplary components of the network architecture 100, in other embodiments, the network architecture 100 may include fewer components, different components, differently arranged components, or additional functional components than depicted in FIG. 1. Additionally, or alternatively, one or more components of the network architecture 100 may perform functions described as being performed by one or more other components of the network architecture 100.

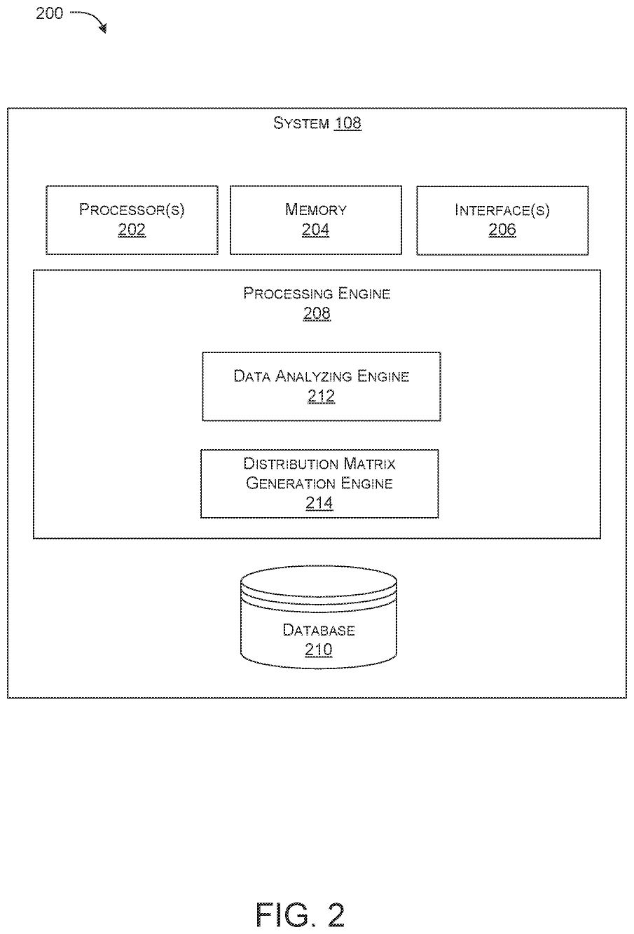

FIG. 2 illustrates a block diagram of an example system for facilitating optimized distribution of data of automotive vehicles, in accordance with an embodiment of the present disclosure.

Referring to FIG. 2, the system 108 may comprise one or more processor(s) 202 that may be implemented as one or more microprocessors, microcomputers, microcontrollers, digital signal processors, central processing units, logic circuitries, and/or any devices that process data based on operational instructions. Among other capabilities, the one or more processor(s) 202 may be configured to fetch and execute computer-readable instructions stored in a memory 204 of the system 108. The memory 204 may be configured to store one or more computer-readable instructions or routines in a non-transitory computer readable storage medium, which may be fetched and executed to create or share data packets over a network service. The memory 204 may comprise any non-transitory storage device including, for example, volatile memory such as random-access memory (RAM), or non-volatile memory such as erasable programmable read only memory (EPROM), flash memory, and the like.

In an embodiment, the system 108 may include an interface(s) 206. The interface(s) 206 may comprise a variety of interfaces, for example, interfaces for data input and output (I/O) devices, storage devices, and the like. The interface(s) 206 may also provide a communication pathway for one or more components of the system 108. Examples of such components include, but are not limited to, processing engine(s) 208 and a database 210, where the processing engine(s) 208 may include, but not be limited to, a data analyzing engine 212 and a distribution matrix generation engine 214.

In an embodiment, the processing engine(s) 208 may be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor-executable instructions stored on a non-transitory machine-readable storage medium and the hardware for the processing engine(s) 208 may comprise a processing resource (for example, one or more processors), to execute such instructions. In the present examples, the machine-readable storage medium may store instructions that, when executed by the processing resource, implement the processing engine(s) 208. In such examples, the system 108 may comprise the machine-readable storage medium storing the instructions and the processing resource to execute the instructions, or the machine-readable storage medium may be separate but accessible to the system 108 and the processing resource. In other examples, the processing engine(s) 208 may be implemented by electronic circuitry.

In an embodiment, the processor 202 may receive a plurality of signals from one or more consumers 102 via a computing device 104 and the store the plurality of signals in the database 210. The one or more consumers 102 may be connected to the processor 202 via a network 106. The plurality of signals may be generated by at least a vehicle associated with the one or more consumers 102 via the data analyzing engine 212. The received plurality of signals may include any or a combination of a sampling rate and a transmission rate. The sampling rate may include the rate of sampling of one or more sensors within the vehicle. The transmission rate may be a rate at which the automotive vehicle may send the sensor signals to the provider,

In an embodiment, the processor 202 may define one or more profiles with the vehicle via the distribution matrix generation engine 214. The defined one or more profiles may be based on one or more vehicle classes and a subscribed frequency. The one or more vehicle classes may include, but not limited to, a fleet, an insurance, and a VSC. The subscribed frequency may be based on the transmission rate of the received plurality of signals. Further, the processor 202 may determine a rating for the received plurality of signals based on the definition of the one or more profiles.

In an embodiment, the processor 202 may map the received plurality of signals to the defined one or more profiles based on the determined rating to generate a vehicle data stream with a data frequency. The data frequency may be based on a step size associated with the definition of the defined one or more profiles and a frequency counter. The processor 202 may generate a distributed frequency array that may contain the frequency counter and the step size to be mapped to the one or more profiles of the vehicle. Further, the processor 202 may distribute the generated vehicle data stream to the one or more consumers 102.

In an embodiment, the processor 202 may process the generated distributed frequency array and a consumer bit mask associated with the one or more profiles of the vehicle.

In an embodiment, the system 108 may include a distributed processing system that may receive the plurality of signals with the transmission rate and distribute the generated vehicle data stream to the one or more consumers 102.

In an embodiment, the processor 202 may dynamically create a plurality of spark jobs based on the received plurality of signals to be mapped with the one or more profiles. The plurality of spark jobs may ensure the mapping for all the received plurality of signals. Further, the processor 202 may be configured to update a signal list associated with the vehicle data stream and ensure the mapping for all the received plurality of signals with the one or more profiles.

Although FIG. 2 shows exemplary components of the system 108, in other examples, the system 108 may include fewer components, different components, differently arranged components, or additional functional components than depicted in FIG. 2. Additionally, or alternatively, one or more components of the system 108 may perform functions described as being performed by one or more other components of the system 108.

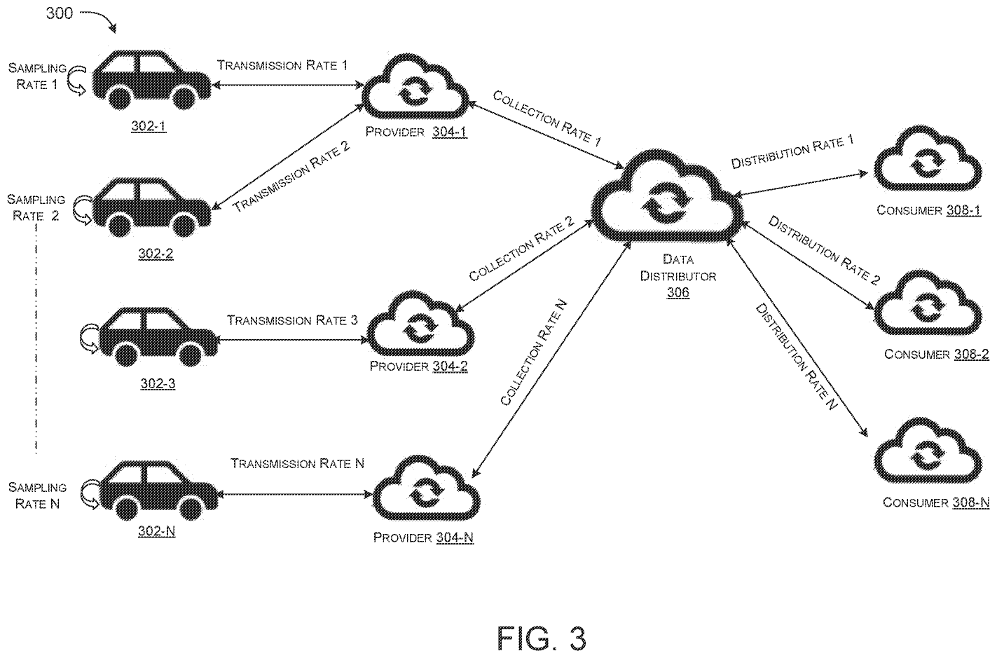

FIG. 3 illustrates an example representation of a data distribution process of automotive signals, in accordance with an embodiment of the present disclosure.

As illustrated in FIG. 3, one or more vehicles 302-1, 302-2, 302-3 . . . 302-N may sample a plurality of signals via one or more sensors with a corresponding sampling rate 1, 2 . . . N. It may be appreciated that the one or more vehicles 302-1, 302-2, 302-3 . . . 302-N may be individually referred as the vehicle 302 and collectively referred as the vehicles 302. Further, the vehicles 302 may send the plurality of signals to one or more providers 304-1, 304-2 . . . 304-N (individually referred as the provider 304 and collectively referred as the providers 304 with corresponding transmission rates 1, 2, 3 . . . N. The one or more providers 304 may further send the plurality of signals to a data distributor 306. The data distributor 306 may receive the plurality of signals at corresponding collection rates 1, 2 . . . N from the one or more providers 304. Further, the data distributor 306 may distribute the plurality of signals to the one or more consumers 308-1, 308-2 . . . 308-N (individually referred as the consumer 308 and collectively referred as the consumers 308) with corresponding distribution rates 1, 2 . . . N. It may be appreciated that the one or more consumers 308 may be similar to the one or more consumers 102 of FIG. 1.

In an embodiment, the system 108 may create a data distribution matrix that may distribute disparate signals across the one or more consumers 308 and determine the data frequency at which the disparate signals are distributed. Further, the system 108 may create a profile pyramid, where the basic signals in the incoming data may be mapped to the base profile of the pyramid and may include additional and more advanced signals. The signal definition in each layer of the pyramid may be based on a common ontology and may be agnostic of the signals defined by the one or more providers 304. In an embodiment, the data distributor 306 may define one or more profile pyramids based on the one or more vehicle classes such as but not limited to fleet, insurance, VSC, etc. The one or more consumers 308 may be tagged to a profile layer within the profile pyramid. Further, the one or more consumers 308 tagged to higher profile layers may receive all the signals corresponding to lower profile layers of the profile pyramid. The data frequency for each profile layer may be selected which may include a configurable frequency parameter with a minimum and maximum value, and a step size for each consumer among the one or more consumers 308. The one or more consumers 308 may select the frequency for each profile pyramid using the range available. The data distributor 306 may distribute the data as the chosen frequency irrespective of the incoming data frequency.

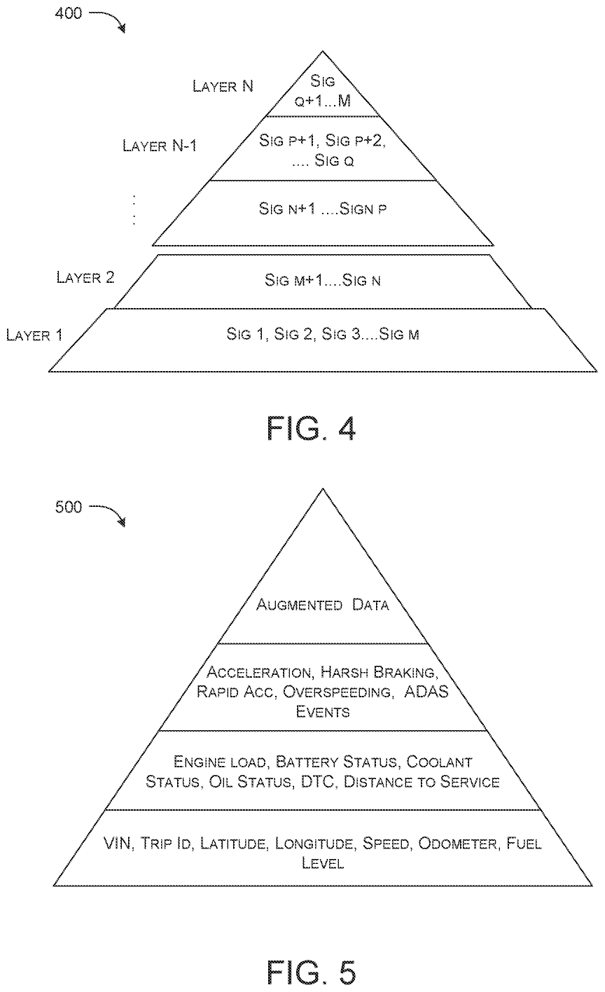

FIG. 4 illustrates an example layered profile pyramid, in accordance with an embodiment of the present disclosure.

As illustrated in FIG. 4, the system 108 may create a profile pyramid 400 and categorize automotive data into various categories that may include, but not limited to, a vehicle profile, a vehicle telemetry, a vehicle health and maintenance mechanism, a driver profile, a driving pattern, and a location. Further, as illustrated in FIG. 4, the system 108 may create an N layered (layer1, layer 2 . . . layer N) profile pyramid with M signals.

In an embodiment, the system 108 may contain different profile pyramids based on the category of data consumers. The breadth of the profile pyramid may be a reflection of the relevance of the signals. Most frequently subscribed signals may be configured at the base of the profile pyramid and least frequently subscribed signals may be configured at a top layer of the profile pyramid.

FIG. 5 illustrates an example profile pyramid based on consumer data, in accordance with an embodiment of the present disclosure.

As illustrated in FIG. 5, the profile pyramid 500 may include four layers, which may include key signals required by a fleet or a VSC. For example, a consumer 102 may subscribe to layer 3 as a fleet consumer when the consumer 102 is interested in the health of the vehicle as well as a driver driving pattern. However, a VSC consumer may subscribe to layer 2 level as a VSC for vehicle health. As illustrated in FIG. 5, layer 1 may include, but not limited to, vehicle identification (VIN), trip identity (ID), latitude, longitude, speed, odometer, and fuel level. Further, layer 2 may include, but not limited to, engine load, battery status, coolant status, oil status, and distance to service (DTS). Layer 3 may include, but not limited, to acceleration, harsh braking, rapid acceleration, overspeeding, and ADAS events. Layer 4 may include, but not limited to, augmented data.

In an embodiment, all vehicles for a data consumer may map to the same profile pyramid and the same layers within that profile pyramid. However, mapping of different vehicles or group of vehicles belonging to the same data consumer may be mapped to different profile pyramids. Further, each vehicle may be mapped only to one profile pyramid covering all consumers that need to ingest data from the vehicle. Additionally, each profile pyramid may be tagged with a distribution frequency array and a consumer bit mask.

In an embodiment, the frequency of distributing data to the data consumer may be a product of step size and unit time. Hence, FQ_{ci}=Step_{ci}*UNIT_TIME, where Step_{ci} may be the step size configured for consumer “C” mapped to the profile pyramid PPᵢ. UNIT_TIME may be a value in seconds within configurable thresholds (MIN_UNIT_TIME<UNIT_TIME<MAX_UNIT_TIME).

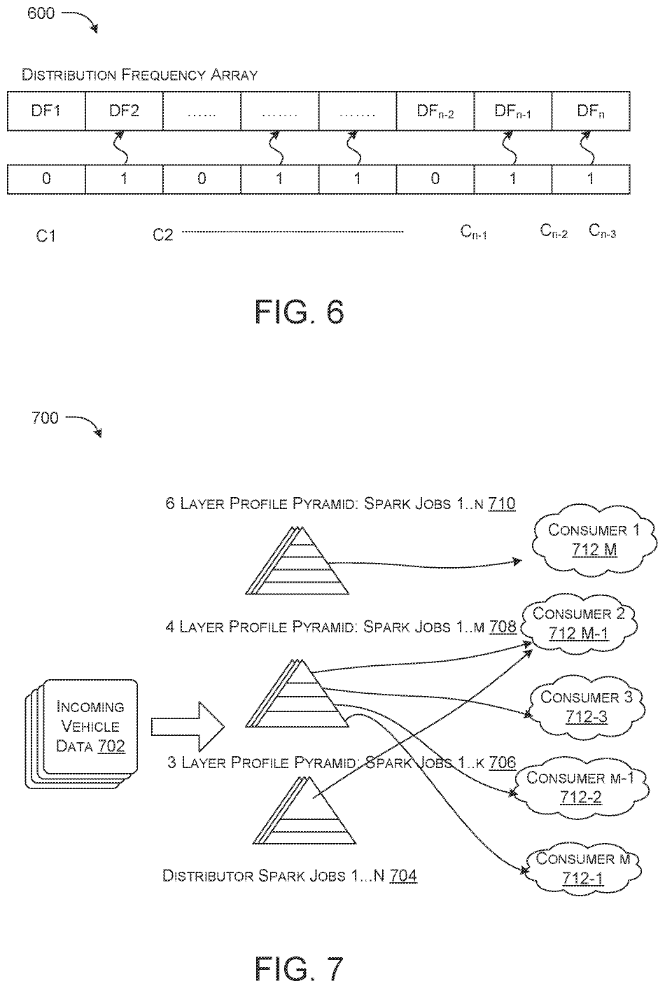

FIG. 6 illustrates an example distribution frequency array, in accordance with an embodiment of the present disclosure.

As illustrated in FIG. 6, in an embodiment, a distribution frequency array (DF₁, DF₂ . . . DF_{N}) may be an 8-bit unsigned character array, where each element of the array may contain a step size and a frequency counter of a consumer 102 mapped to a profile pyramid. Here, 0-3 bits may represent the configured step size for the consumer 102 mapped to the profile pyramid. 4-8 bits may represent the counter that may be updated for every packet distributed and may be reset once the counter reaches the value of step size. In addition to the distribution frequency array, each profile pyramid layer may maintain a consumer bit mask, where the bit may be toggled based on the mapping of the consumer 102 to the specific profile pyramid layer. Further, the frequency of distribution for a consumer 102 mapped to a specific profile pyramid may remain same irrespective of the number of signals.

In an embodiment, one or more spark jobs may be created to process different pyramid profiles to ensure parallel processing. The number of spark jobs per profile pyramid may be a function of a number of vehicles mapped to the profile pyramid. Hence, for the profile pyramid PPᵢ, with number of signal layers Lᵢ, number of spark jobs Jᵢ may be created such that Jᵢ=Vᵢ % Max_vehicles, where Max_vehicles may be the total number of vehicles that one instance of spark job may handle for the profile pyramid PPᵢ. Additional spark jobs may be spawned as the vehicle traffic increases which may be a dynamic process to ensure utilization of resources. Further, each incoming packet may include a VIN to be used to identify the profile pyramid and hence the spark job to distribute the data.

In an embodiment, on receiving the incoming packet containing multiple signals (SL=S₁, S₂ . . . S_{N}), the following steps may be used to distribute the signals.

At step 1: This step may include finding the signal Sₚ, such that all other signals in the packet belong to either the same layer Lj as Sₚ or to a lower layer (L1 to Lᵢⱼ−1), where Sₚ∈SL and Lᵢⱼ is the j^{th} layer of the profile pyramid PPᵢ.

At step 2: This step may include finding the consumers mapped to layer Lᵢⱼ using the consumer bit mask. Further, if the data is due to be sent (as set in the distribution frequency array), this step may include distributing all the signals to the consumers 102 set in layer Lᵢⱼ.

At step 3: This step may include updating the signal list (SL) after removing the signal Sⱼ and all signals that lie in layer Lᵢⱼ, SL=SL−{Sₚ+other signals in Layer Lᵢⱼ}.

At step 4: This step may include verifying if additional signals exist in the SL or if consumers exist in the lower layers. Based on a positive determination, this step may include exiting. Based on a negative determination, this step may include revisiting step 5.

At step 5: This step may include repeating steps 1 to 4 for signals in the SL until there are no consumers in the lower layers or if the SL is out of phase.

FIG. 7 illustrates an example data signal distribution mechanism of the example system, in accordance with an embodiment of the present disclosure.

As illustrated in FIG. 7, incoming vehicle data 702 may be sent to various profile pyramids where the actual mechanism of distribution of data signals may be specific to the data consumer/consumers 712-1, 712-2, 712-3 . . . 712-M−1, 712-M. The profile pyramids may include, but not limited to, distributor spark jobs 1 . . . N 704, 3 layer profile pyramid with spark jobs 1 . . . k 706, 4 layer profile pyramid spark jobs 1 . . . m 708, and 6 layer profile pyramid with spark jobs 1 . . . n 710. Further, various vehicle data streams may be distributed by the profile pyramids to various consumers 712-1, 712-2, 712-3 . . . 712-M−1, 712-M.

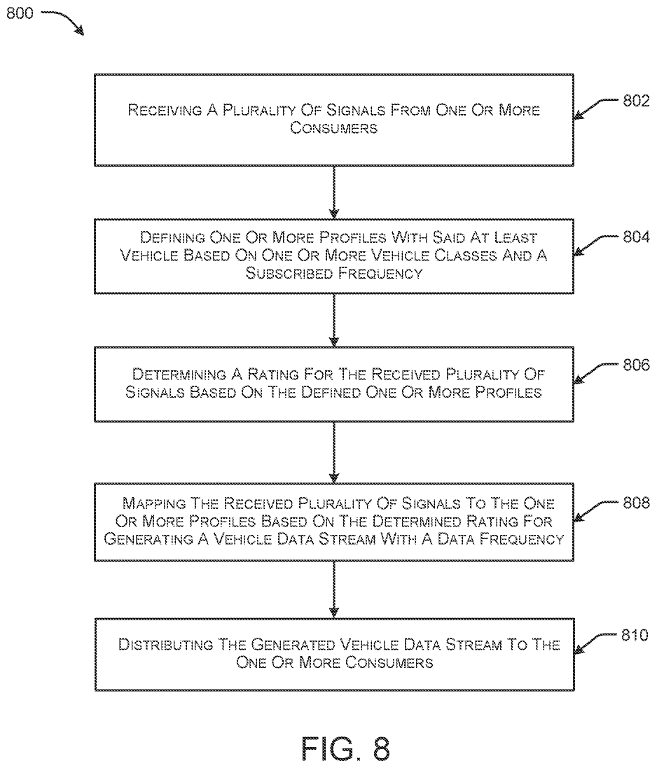

FIG. 8 illustrates an example method for generating and distributing vehicle data stream, in accordance with an embodiment of the present disclosure.

As illustrated in FIG. 8, the method 800 for generating the vehicle data stream may include the following steps.

At step 802: The method 800 may include receiving, by a processor (e.g., 202) associated with the system (e.g., 108), a plurality of signals from one or more consumers 102. The plurality of signals may be generated by at least a vehicle associated with the one or more consumers 102.

At step 804: The method 800 may include defining, by the processor 202, one or more profiles with said at least vehicle based on one or more vehicle classes and a sub scribed frequency.

At step 806: The method 800 may include determining, by the processor 202, a rating for the received plurality of signals based on the defined one or more profiles.

At step 808: The method 800 may include mapping, by the processor 202, the received plurality of signals to the defined one or more profiles based on the determined rating for generating a vehicle data stream with a data frequency.

At step 810: The method 800 may include distributing, by the processor 202, the generated vehicle data stream to the one or more consumers 102.

Therefore, the present disclosure provides a system (e.g., 108) and a method (e.g., 800) that collects trip automotive data from different sources within the vehicle, where signals are collected at a different frequency based on the criticality and relevance of change in signal values. The disclosed system and method ensure that automotive data distribution meets a complex requirement of advanced data distribution without adding a processing overhead on consumer, distributor, or both. Further, the disclosed system and method create a data distribution matrix that addresses a need to distribute disparate signals across consumers as well as a frequency at which the signals are distributed.

Furthermore, the disclosed system and method create a profile pyramid where basic signals in the incoming data are mapped to the base profile of the pyramid with an inclusion of additional and advanced signals. The data consumer may select the frequency for each profile pyramid using an available range. Additionally, a distributor distributes data at a data frequency irrespective of the incoming data frequency.

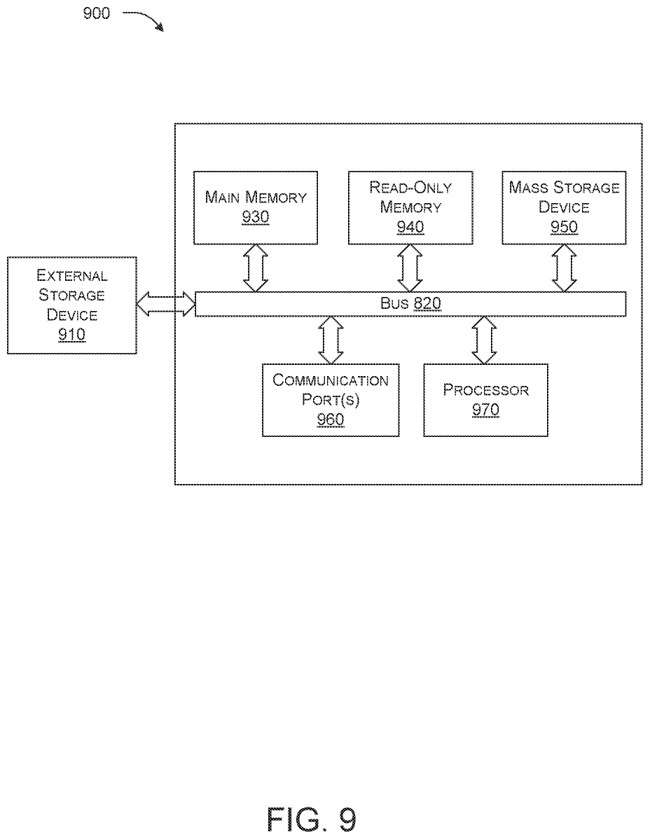

FIG. 9 illustrates an example computer system in which or with which embodiments of the present disclosure may be implemented.

As shown in FIG. 9, the computer system 900 may include an external storage device 900, a bus 920, a main memory 930, a read-only memory 940, a mass storage device 950, a communication port(s) 960, and a processor 970. A person skilled in the art will appreciate that the computer system 900 may include more than one processor and communication ports. The processor 970 may include various modules associated with embodiments of the present disclosure. The communication port(s) 960 may be any of an RS-232 port for use with a modem-based dialup connection, a 10/100 Ethernet port, a Gigabit or Gigabit port using copper or fiber, a serial port, a parallel port, or other existing or future ports. The communication ports(s) 960 may be chosen depending on a network, such as a Local Area Network (LAN), Wide Area Network (WAN), or any network to which the computer system 900 connects.

In an embodiment, the main memory 930 may be Random Access Memory (RAM), or any other dynamic storage device commonly known in the art. The read-only memory 940 may be any static storage device(s) e.g., but not limited to, a Programmable Read Only Memory (PROM) chip for storing static information e.g., start-up or basic input/output system (BIOS) instructions for the processor 970. The mass storage device 950 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus 920 may communicatively couple the processor(s) 970 with the other memory, storage, and communication blocks. The bus 920 may be, e.g. a Peripheral Component Interconnect PCI)/PCI Extended (PCI-X) bus, Small Computer System Interface (SCSI), (USB), or the like, for connecting expansion cards, drives, and other subsystems as well as other buses, such a front side bus (FSB), which connects the processor 970 to the computer system 900.

In another embodiment, operator and administrative interfaces, e.g., a display, keyboard, and cursor control device may also be coupled to the bus 920 to support direct operator interaction with the computer system 900. Other operator and administrative interfaces can be provided through network connections connected through the communication port(s) 960. Components described above are meant only to exemplify various possibilities. In no way should the aforementioned exemplary computer system 900 limit the scope of the present disclosure.

The methods described herein may be performed using the systems described herein. In addition, it is contemplated that the methods described herein may be performed using systems different than the systems described herein. Moreover, the systems described herein may perform the methods described herein and may perform or execute instructions stored in a non-transitory computer-readable storage medium (CRSM). The CRSM may comprise any electronic, magnetic, optical, or other physical storage device that stores executable instructions. The instructions may comprise instructions to cause a processor to perform or control performance of operations of the proposed methods. It is also contemplated that the systems described herein may perform functions or execute instructions other than those described in relation to the methods and CRSMs described herein.

Furthermore, the CRSMs described herein may store instructions corresponding to the methods described herein, and may store instructions which may be performed or executed by the systems described herein. Furthermore, it is contemplated that the CRSMs described herein may store instructions different than those corresponding to the methods described herein, and may store instructions which may be performed by systems other than the systems described herein.

The methods, systems, and CRSMs described herein may include the features or perform the functions described herein in association with any one or more of the other methods, systems, and CRSMs described herein.

In some embodiments the method or methods described above may be executed or carried out by a computing system (for example, the computer system 900 of FIG. 9) including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the invention should be determined by the appended claims and their legal equivalents.

1. A system for an optimized distribution of data, the system comprising:
a processor; and
a memory operatively coupled with the processor, wherein said memory stores instructions, which when executed by the processor, causes the processor to:
receive a plurality of signals from one or more consumers via a computing device, wherein the plurality of signals are generated by at least a vehicle associated with the one or more consumers;
define one or more profiles associated with said at least vehicle based on one or more vehicle classes and a subscribed frequency;
determine a rating for the received plurality of signals based on the defined one or more profiles;
map the received plurality of signals to the defined one or more profiles based on the determined rating to generate a vehicle data stream with a data frequency; and
distribute the generated vehicle data stream to the one or more consumers.

2. The system of claim 1, wherein the received plurality of signals comprises at least one of: a sampling rate and a transmission rate.

3. The system of claim 1, wherein the generated data frequency comprises at least one of: a collector rate and a distributor rate.

4. The system of claim 1, wherein the one or more vehicle classes comprise at least one of: a fleet, an insurance, and a vehicle stability control (VSC).

5. The system of claim 2, wherein the subscribed frequency is based on the transmission rate of the received plurality of signals.

6. The system of claim 1, wherein the data frequency is based on a step size associated with the defined one or more profiles and a frequency counter.

7. The system of claim 2, further comprising a distributed processing system that receives the plurality of signals with the transmission rate and distributes the generated vehicle data stream to the one or more consumers.

8. The system of claim 1, wherein the processor is to dynamically create a plurality of spark jobs based on the received plurality of signals to be mapped with the one or more profiles.

9. The system of claim 6, wherein the processor is to generate a distributed frequency array comprising the frequency counter and the step size to be mapped to the one or more profiles of said at least vehicle.

10. The system of claim 9, wherein the processor is to process the distributed frequency array and a consumer bit mask associated with the one or more profiles of said at least vehicle.

11. The system of claim 1, wherein the processor is to update a signal list associated with the vehicle data stream and ensure the mapping for all the received plurality of signals with the one or more profiles.

12. A method for an optimized distribution of data, the method comprising:
receiving, by a processor associated with a system, a plurality of signals from one or more consumers, wherein the plurality of signals are generated by at least a vehicle associated with the one or more consumers;
defining, by the processor, one or more profiles associated with said at least vehicle based on one or more vehicle classes and a subscribed frequency;
determining, by the processor, a rating for the received plurality of signals based on the defined one or more profiles;
mapping, by the processor, the received plurality of signals to the defined one or more profiles based on the determined rating for generating a vehicle data stream with a data frequency; and
distributing, by the processor, the generated vehicle data stream to the one or more consumers.

13. The method of claim 12, wherein the received plurality of signals comprises at least one of: a sampling rate and a transmission rate.

14. The method of claim 12, wherein the data frequency is based on a step size associated with the defined one or more profiles and a frequency counter.

15. The method of claim 12, further comprising dynamically creating, by the processor, a plurality of spark jobs based on the received plurality of signals to be mapped with the one or more profiles.

16. The method of claim 14, further comprising generating, by the processor, a distributed frequency array that comprises the frequency counter and the step size to be mapped to the one or more profiles of said at least vehicle.

17. The method of claim 16, further comprising processing, by the processor, the generated distributed frequency array and a consumer bit mask associated with the one or more profiles of said at least vehicle.

18. The method of claim 12, wherein the one or more vehicle classes comprise at least one of: a fleet, an insurance, and a vehicle stability control (VSC).

19. The method of claim 12, further comprising updating, by the processor, a signal list associated with the vehicle data stream and ensuring the mapping for all the received plurality of signals with the one or more profiles.

20. A non-transitory computer readable medium comprising a processor with executable instructions, causing the processor to:
receive a plurality of signals from one or more consumers via a computing device, wherein the plurality of signals are generated by at least a vehicle associated with the one or more consumers;
define one or more profiles associated with said at least vehicle based on one or more vehicle classes and a subscribed frequency;
determine a rating for the received plurality of signals based on the defined one or more profiles;
map the received plurality of signals to the one or more profiles based on the determined rating to generate a vehicle data stream with a data frequency; and
distribute the generated vehicle data stream to the one or more consumers.
